(19) United States
(12) Patent Application Publication
(10) Pub. No.: US 2025/0380108 A1
(43) Pub. Date: Dec. 11, 2025

(54) COMMUNICATION SYSTEM FOR COMMUNICATION WITH VEHICLES BASED ON ESTABLISHED GEOFENCES

(71) Applicant: Magna Electronics Inc., Auburn Hills, MI (US)

(72) Inventor: Francis Judge, South Lyon, MI (US)

(21) Appl. No.: 19/233,106

(22) Filed: Jun. 10, 2025

Related U.S. Application Data
(60) Provisional application No. 63/658,509, filed on Jun. 11, 2024.

(51) Int. Cl. H04W 4/021; H04W 4/38; H04W 4/90

(52) U.S. Cl. CPC H04W 4/021; H04W 4/38; H04W 4/90

(57) ABSTRACT

A communication system includes a server operable to communicate with vehicles located remote from the server. The server is operable to receive an indication of an event that occurs remote from the server. The indication identifies a location associated with the event. The server, responsive to receiving the indication of the event, establishes a geofence that bounds the location associated with the event. The server transmits information pertaining to the established geofence to at least one of the group consisting of (i) a vehicle within the established geofence and (ii) a vehicle within a threshold distance of the established geofence. When a vehicle that received the transmitted information is within the established geofence, the server receives, from the respective vehicle within the established geofence, information derived from sensor data captured by at least one sensor of the vehicle within the established geofence.

### CROSS REFERENCE TO RELATED APPLICATION

The present application claims the filing benefits of U.S. provisional application Ser. No. 63/658,509, filed Jun. 11, 2024, which is hereby incorporated herein by reference in its entirety.

### FIELD OF THE INVENTION

The present invention relates generally to a vehicle vision system for a vehicle and, more particularly, to a vehicle vision system that utilizes one or more cameras at a vehicle.

### BACKGROUND OF THE INVENTION

Use of imaging sensors in vehicle imaging systems is common and known. Examples of such known systems are described in U.S. Pat. Nos. 5,949,331; 5,670,935 and/or 5,550,677, which are hereby incorporated herein by reference in their entireties.

### SUMMARY OF THE INVENTION

A communication system includes a server operable to communicate with vehicles located remote from the server. The server is operable to receive an indication of an event that occurs remote from the server. The indication identifies a location associated with the event. The server, responsive to receiving the indication of the event, establishes a geofence that bounds the location associated with the event. The server transmits information pertaining to the established geofence to at least one of the group consisting of (i) a vehicle within the established geofence and (ii) a vehicle within a threshold distance of the established geofence. When a vehicle that received the transmitted information is within the established geofence, the server receives, from the respective vehicle within the established geofence, information derived from sensor data captured by at least one sensor of the vehicle within the established geofence.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a vision system that incorporates cameras;

FIG. 2 is a flow chart for using a geofence to mark a boundary for transferring sensor data; and

FIG. 3 is a block diagram of a vehicular communication system that communicates via a private blockchain.

### DESCRIPTION OF THE PREFERRED EMBODIMENTS

A vehicle sensing system and/or driver or driving assist system and/or object detection system and/or alert system operates to capture images exterior or interior of the vehicle and may process the captured image data to display images and to detect objects at or near the vehicle and in the predicted path of the vehicle, such as to assist a driver of the vehicle in maneuvering the vehicle in a forward or rearward direction. The vision system includes an image processor or image processing system that is operable to receive image data from one or more cameras and provide an output to a display device for displaying images representative of the captured image data. Optionally, the vision system may provide a display, such as a rearview display or a top down or bird's eye or surround view display or the like.

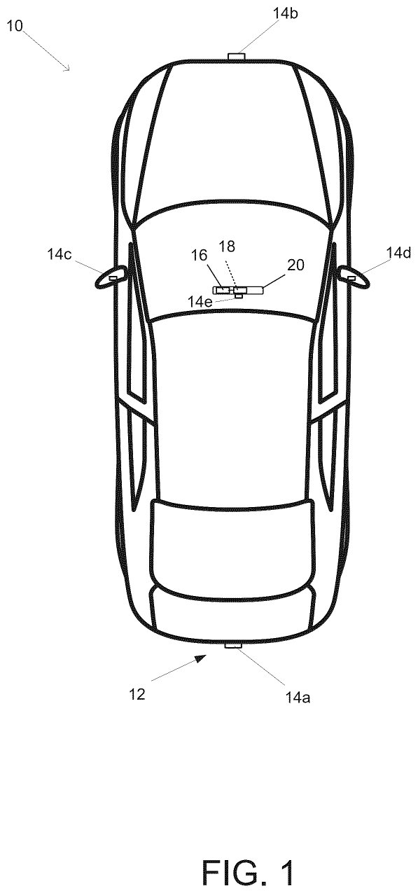

Referring now to the drawings and the illustrative embodiments depicted therein, a vehicle 10 includes an imaging system or vision system 12 that includes at least one exterior viewing imaging sensor or camera, such as a rear backup camera or rearward viewing imaging sensor or camera 14a (and the system may optionally include multiple exterior viewing imaging sensors or cameras, such as a forward viewing camera 14b at the front (or at the windshield) of the vehicle, and a sideward/rearward viewing camera 14c, 14d at respective sides of the vehicle, and/or one or more interior viewing cameras, such as a driver monitoring camera 14e), which captures images exterior (or interior) of the vehicle, with the camera having a lens for focusing images at or onto an imaging array or imaging plane or imager of the camera (FIG. 1). Optionally, a forward viewing camera may be disposed at the windshield of the vehicle and view through the windshield and forward of the vehicle, such as for a machine vision system (such as for traffic sign recognition, headlamp control, pedestrian detection, collision avoidance, lane marker detection and/or the like). The vision system 12 includes a control or electronic control unit (ECU) 18 having electronic circuitry and associated software, with the electronic circuitry including a data processor or image processor that is operable to process image data captured by the camera or cameras, whereby the ECU may detect or determine presence of objects or the like and/or the system provide displayed images at a display device 16 for viewing by the driver of the vehicle (although shown in FIG. 1 as being part of or incorporated in or at an interior rearview mirror assembly 20 of the vehicle, the control and/or the display device may be disposed elsewhere at or in the vehicle). The data transfer or signal communication from the camera to the ECU may comprise any suitable data or communication link, such as a vehicle network bus or the like of the equipped vehicle.

Geofencing refers to establishing a virtual perimeter around a physical location. Modern vehicles include many sensors operable to capture sensor data that may be beneficial to first responders to an accident or other emergency event near the equipped vehicle. At least some implementations herein are directed toward a system that allows first responders, emergency services, or other authorized entities (e.g., public safety answering points (PSAPs), transportation management centers, disaster response agencies) to establish a geofence around an area (e.g., an area surrounding a traffic accident). Within the geofence, one or more vehicles and/or infrastructure elements (e.g., smart traffic signals, roadside sensor units, or connected infrastructure) and/or mobile devices (e.g., smartphones of bystanders, occupants, or emergency personnel on scene) provide data regarding the status of the are within the geofence in order to enable the establishing entity to gain enhanced situational awareness, manage resources more effectively, and improve safety outcomes.

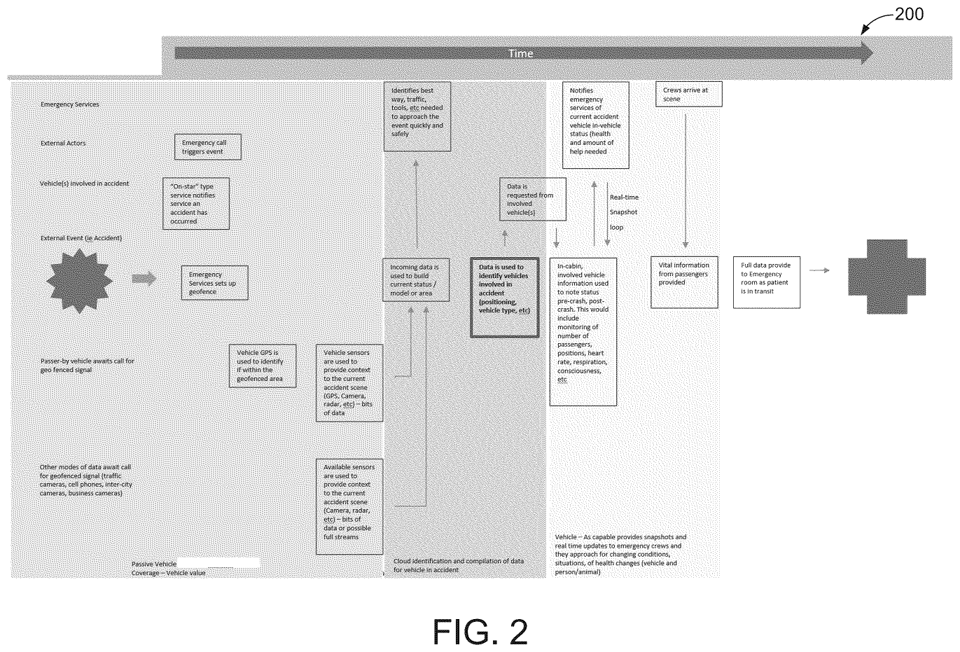

Referring now to FIG. 2, a flow chart 200 includes steps by emergency services (or other entities), external actors (such as other vehicles, pedestrians, etc.), one or more vehicles involved in an accident or other event triggering the geofence, other vehicles equipped with sensors that are within the geofence, and other infrastructure elements within the geofence. An external event (e.g., an accident) initiates the process for establishing the geofence. In the following example, the triggering event is a vehicular accident, but any event requiring assistance or follow-up by emergency services or other third parties may trigger the geofence, including, for example, a fire, a hazardous material spill, any major traffic disruption, an AMBER alert situation, a public safety threat, a large public event requiring traffic and crowd management, and/or a natural disaster such as an earthquake, flood, or severe weather event.

Here, an external actor (e.g., a bystander or occupant of another vehicle) reports the accident (e.g., via calling 911 or the like) or one of the vehicles involved in the accident (or one of the occupants) reports the accident. The accident may be reported via an in-vehicle system such as an automated emergency call system, a telematics service, a vehicle's integrated communication system, or an online service that automatically detects an accident or is invoked via a user interaction within the vehicle or via a smartphone application communicatively coupled to emergency dispatch systems. This triggers emergency services (or other entities receiving the triggering event) to establish the geofence. The geofence may be established at a predetermined distance around a geographical location associated with the triggering event. For example, a bystander reporting the accident may provide a location that may be converted to GPS coordinates. Alternatively, a vehicle involved in or reporting the accident may provide GPS coordinates indicating the vehicle's location. The geofence may be established as a perimeter around the GPS coordinates. The perimeter may be defined by a radius from a central point, or as a more complex polygon to cover a specific roadway segment or area of interest. The geofence may have a predetermined size (e.g., 10 meters, 50 meters, 100 meters, 500 meters, 1,000 meters, etc.). The size of the area within the geofence may be dynamic based on various parameters, such as a type or size of the accident, a location of the accident, current environmental conditions, the density of vehicular or pedestrian traffic, the speed limits on affected roads, the type of emergency response required (e.g., fire, medical, police), the potential for secondary incidents, available detour routes, and/or pre-defined incident response protocols, etc. For example, if the event is a severe multi-vehicle collision that is stopping traffic in one or more traffic lanes, a larger-sized geofence may be established as compared to a smaller-sized geofence that may be established when the event is a minor accident that is moved off the road.

Vehicles and other entities (e.g., infrastructure elements such as traffic cameras, cell phones of bystanders or other individuals within the geofence, unmanned aerial vehicles (UAVs) or drones deployed by authorities or participating entities, etc.) determine that they are within the geofence area (e.g., by comparing their current GNSS-derived location with geofence boundary information received via broadcast or direct communication) and capture sensor data to provide context of the current scene to emergency services (or other entity that established the geofence). The sensor data captured may include video streams (from various camera types including color, infrared, or thermal), still images, radar detections (including range, speed, and object classification), LIDAR point clouds, audio recordings (e.g., from in-vehicle microphones or external microphones on infrastructure), vehicle telemetry data (e.g., speed, acceleration, braking status, steering angle, airbag deployment signals), and environmental data (e.g., temperature, precipitation, visibility). For example, a vehicle passing by the accident that also passes through the geofence established by emergency services, captures image data, radar data, LIDAR data, etc., representative of the scene. The vehicle may process this sensor data locally or in conjunction with remote computing resources to determine and provide context information of the scene (e.g., via a wireless data connection) to emergency services. In other examples, the vehicle provides some or all the raw data (optionally with some level of pre-processing and/or filtering), and emergency services or designated processing centers process the data for context information.

Context information, as used herein, refers to any information regarding a state of the scene within the geofence area. For example, the context information includes information regarding the vehicle(s) within the geofence (e.g., vehicle types, sizes, positions, orientations, visible damage, number of occupants, status of vehicle systems such as engine on/off, lights active, or hazard indicators flashing, and whether doors or windows are open or closed, etc.). The vehicles involved in the accident may be identified based on the context information. In other examples, the context information includes a status of any people/animals within the geofence area (e.g., position, movement, apparent injuries, whether anyone is assisting, indications of consciousness, and proximity to hazards, etc.). The context information may include various environmental conditions, such as weather conditions (e.g., rain, fog, snow, wind speed), lighting conditions (e.g., day, night, twilight, presence of streetlights), road conditions (e.g., wet, icy, debris on road), traffic conditions (e.g., congestion levels, speed of passing traffic), air quality information (e.g., presence of smoke or hazardous fumes detected by specialized sensors), etc. The vehicle(s) involved in the accident may provide context information. For example, in-cabin sensors (e.g., interior viewing cameras, microphones, seat weight sensors, cabin air quality sensors, etc.) may provide context information for both pre-accident and post-accident time periods. The context information may include monitoring of the occupants of the vehicle (e.g., number of occupants, positions, estimated age range, gender, presence of child seats, heart rates, respiration, consciousness, etc.).

Optionally, the context information includes sensor data that was captured prior to and during the event and stored in a temporary memory buffer of the vehicle. For example, when the triggering event is a collision detected by one of the vehicles involved (e.g., through airbag deployment sensors, g-force sensors, or other automated crash detection systems), or detected by any other means, such as by a nearby vehicle or an infrastructure camera or sensor, the system may automatically establish the geofence or trigger the establishment of the geofence, and in this scenario, data recorded by the involved vehicle(s) and/or other vehicles prior to the geofence being established may be provided. Many vehicle systems incorporate event data recorders or similar functionalities that continuously record sensor inputs-such as video feeds from internal or external cameras, vehicle speed, braking and steering inputs, and inertial measurements-on a short, continuous loop (e.g., buffering the last 10 seconds, 30 seconds, 1 minute, or another defined period of data). Upon detection of a significant event like a vehicle being involved in a collision, this buffered data (which may be captured and buffered at the vehicle or vehicles involved in the collision and/or may be captured and buffered at other vehicles nearby the collision and within the established geofence, such as at a vehicle trailing an involved vehicle) leading up to and encompassing the event can be automatically preserved or locked from being overwritten and then transmitted as part of the context information.

Thus, for example, when a vehicle is involved in a collision (with another vehicle or obstacle), the system may automatically generate a geofence around the region where the collision occurred, and may receive buffered data and real-time data captured by other vehicles (such as a trailing vehicle that was following the involved vehicle). They system may, via processing of the received data, determine how the collision occurred and may determine the present situation, such as severity of the collision and condition of the involved vehicle and/or its occupants. This pre-incident and incident-specific and post-incident data may enable emergency services or other authorized entities to understand the sequence of events, the severity of the impact, and the potential state of the involved vehicle and its occupants.

Vehicles (and other devices, such as traffic cameras, cell phones, wearable devices of individuals, etc.) may determine they are within the geofence area based on a location of the geofence area (e.g., GPS coordinates and defined boundary parameters) relative to a current location of the vehicle (or other sensor). For example, emergency services, when initiating the geofence, broadcast the location of the geofence to some or all devices within a threshold range of the geofence area. In some implementations, this broadcast may be directed to a subset of vehicles or devices based on their proximity to the geofence or their likely path toward the geofence. For example, the system may utilize cellular network infrastructure to disseminate the geofence information. In some examples, the emergency services may interface with cellular network providers to broadcast the geofence parameters through cell towers covering the geographical area encompassing and surrounding the geofence. This approach may allow for targeting devices connected to specific cell towers or sectors anticipated to include vehicles approaching the incident area. Optionally, the system may leverage vehicle-to-infrastructure or vehicle-to-everything (V2X) communication capabilities, such as dedicated short-range communications (DSRC) or cellular V2X, to broadcast the geofence information directly to appropriately equipped vehicles within a certain range. In another example, the broadcast may be facilitated by infrastructure (e.g., roadside units) strategically positioned along roadways leading to or within the vicinity of the geofence to relay the geofence information to passing vehicles. The selection of the subset of vehicles may also be based on traffic flow data, predicting which vehicles are most likely to enter or be affected by the geofenced area.

For example, a wireless communication may be sent to receivers/devices within a general region that encompasses the geofence and regions surrounding the geofence (e.g., within 2,000 meters of the geofence or within 1,000 meters of the geofence or within 500 meters of the geofence). The devices that receive the wireless communication may be within the geofence when they receive the wireless communication or may be outside of the geofence but in the general vicinity of the geofence when they receive the wireless communication. Devices within the geofence (e.g., devices within the geofence when the wireless communication is received and devices that receive the wireless communication when outside of the geofence but then enter the geofence) are requested to provide context information. Each device, when receiving an indication of the geofence, determines whether the device is within the geofence. When within the geofence, the device may provide context information to the extent the device is capable and permitted by user settings or pre-configured protocols. The location and status (e.g., active, inactive, modified boundaries, etc.) of the geofence may be continuously or periodically broadcast to continuously or periodically update the devices notified. Vehicles may continuously or periodically check for active geofences (e.g., by querying a central geofence registry or listening for broadcast messages) and whether the current location of the vehicle is within the area of an active geofence. That is, the status of a geofence may be “pushed” to the vehicle. Additionally or alternatively, the vehicles may “pull” the status of the geofence by actively querying a server or network service.

Based on the context information, emergency services builds a model or current status of the area within the geofence. This model may be a dynamic, multi-layered digital representation of the scene, optionally including a 2D map overlay, a 3D reconstruction of the environment, and/or a timeline of events derived from the aggregated sensor data. Based on this model, emergency services may identify an optimal way to approach the scene (e.g., avoiding blocked routes or hazardous areas identified by sensors) and resolve the emergency, an amount and/or type of help needed, and/or an urgency of the help needed. The context information may be updated continuously or periodically while waiting for emergency services to arrive at the scene and while emergency services render aid at the scene. For example, the information provided may include information about occupants of a vehicle involved in a crash, including how many occupants, occupant status, such as, for example, whether or not an occupant is going into shock, and the information may include information about other people already on the scene and assisting, in order to help the emergency services to be better prepared for what to expect when they arrive at the scene of an accident. The context information may be updated and provided to hospitals or other entities such as trauma centers or disaster management agencies as needed based on the outcome of the event. A distributed computing system (e.g., a cloud computing system) may be leveraged to process or determine or derive the context information from the sensor data.

In some examples, an external actor providing context information is an autonomous vehicle that renders aid by providing transport to a hospital or by parking and providing continuous context information updates by continual monitoring of the area within the geofence. The context information may be used to identify particular vehicles which allows querying for additional information from the identified vehicles. For example, a vehicle involved in an accident may be identified based on context information from an external actor (e.g., license plate recognition from a passing vehicle's camera, vehicle identifiers broadcast by the vehicle itself), and based on that identification, the vehicle involved in the accident may be queried (e.g., via wireless communications) for additional context information (e.g., number of occupants, a status of the occupants of the vehicle, airbag deployment status, impact sensor data, or even pre-crash telemetry data, etc.). Optionally, the context information (or sensor data) may be fully or partially anonymized prior to processing by emergency services to maintain privacy (e.g., via anonymous transactions of data as described in more detail below or by applying privacy-preserving algorithms such as data masking or k-anonymity). The information obtained from the vehicles and devices within the geofence may be used to assist in re-creating crash scenarios, such as to determine fault of an accident or collision, improve future road safety designs, and/or for training emergency response personnel.

Many vehicles are equipped with driver monitoring systems (DMS) and/or occupant monitoring systems (OMS). Generally, these systems can detect whether the driver's attention is directed towards the road or elsewhere. In cases where the driver's attention is diverted, the system has the capability to alert the driver via visual and/or auditory alarms. However, traditionally these systems rely on the vulnerability of the driver being inattentive while driving. That is, these systems do not measure and/or report the performance of drivers who are not prone to distractions/drowsiness (at least to a threshold level). In at least some implementations herein, a DMS and/or OMS provides an “attention economy” rating or value to serve as motivation for a driver's self-alertness for driving. Similar to how fuel economy uses existing measurement metrics to display certain performance metrics, attention economy motivates drivers to maintain a certain level of attention and thus enables drivers to be more “vehicle-aware” or “vehicle-conscious” drivers. The attention economy may be easily available/visible (e.g., via a dedicated display on the instrument cluster, a widget on the infotainment screen, an audible summary upon request) to allow the drivers to be aware or conscious of their attention. Optionally, the rating may be integrated into a smartphone application for review post-drive, allowing for trend analysis and/or gamification elements.

Economy has long served as a powerful motivator. The term “attention economy” thus serves as a motivator for the driver. That is, using the term “attention” and the term “economy” together can notify the driver that attention is a significant factor for a person behind the wheel and it should not be dealt with negligently. The system can also provide personal rewards to the driver for being an attentive driver. These rewards may be in the form of positive feedback messages, badges or achievements within a vehicle or app interface, or tied to external incentive programs such as insurance discounts or loyalty points from the vehicle manufacturer or third-party partners. Just as fuel is required by a vehicle and fuel economy can be an important performance metric of the vehicle, attention is required by the driver and attention economy can be an important performance metric of the driver. To the extent that attention is a vulnerability, incorporating attention economy in a vehicle can mitigate this vulnerability by making it a measurable and manageable aspect of driving performance, encouraging proactive engagement rather than reactive correction. A motivation behind a DMS is to prevent vehicle accidents that occur due to inattentive driving or driver drowsiness. Extending this, systems and methods described herein may, in addition to reminding the driver to pay attention, also reward the driver if they have been sufficiently attentive overall. This can serve to create more autonomously attentive drivers or active attentive drivers, rather than passive attentive drivers. That is, the DMS with the attention economy feature may not end up increasing a driver's dependency on the feature, but instead serve to strengthen a driver's capabilities. The effect may be gradual, as drivers will be able to see the change in its economy, going positive on good days, and going negative on other days. The system can act as a beginning to increase driver attentiveness. With this, the system will not only act towards preventing accidents that occur due to lack of attention, but the system will also act directly at the root of the issue (i.e., inattentiveness itself). Thus, instead of or in addition to preventing an accident that can be attributed to a certain cause, the system helps to mitigate the cause itself. For example, by providing positive reinforcement for sustained attention, the system may help condition the driver to maintain focus even without explicit prompts, thereby fostering a more ingrained habit of attentive driving.

The system may measure the attention economy in several different ways. For example, the DMS may produce a certain value for each attention zone within a field of view of a camera. These attention zones may include the forward roadway, instrument cluster, center display, rearview mirror, and side mirrors. The system may assign different weights to dwell times or gaze patterns within these zones based on their relevance to the current driving task. The attention economy may be an average value taken over each driving period that varies as the driver drives the vehicle. The system may include an additional “alpha” factor that determines a threshold amount of attention required based on the current driving mode or driving scenario (e.g., environmental conditions, traffic conditions, vehicle speed, complexity of the driving environment such as urban versus highway driving, etc.). For example, the alpha factor may demand a higher attention level during manual driving in dense city traffic compared to highway driving with adaptive cruise control engaged. The driver may be able to reset the system when required or desired (e.g., based on an OEM configuration or at the beginning of a new trip or evaluation period).

A representation of the attention economy (e.g., a current value or a plot of recent values, a graphical icon that changes appearance based on the score, an ambient light display that changes color or intensity, etc.) may be displayed on one or more displays within the vehicle, such as at the cluster or a head-up display (HUD). Additionally or alternatively, the attention economy may be displayed in response to a user input (e.g., a button press, voice command, gesture, periodically as a summary, etc.). The attention economy may be assigned only positive real values, for example based on a range from 0-100, with 100 being the highest (i.e., full attention) and 0 being the lowest (i.e., little attention). Optionally, the system may provide qualitative feedback, such as “Excellent Attention” or “Focus Recommended,” in addition to or in place of a numerical score. The display may also show trends over time, allowing the driver to track their improvement or identify periods of lower attention.

Determining the values of the attention-economy may not require any additional hardware capabilities for existing DMS and OMS features. For example, the attention economy may be added as an additional signal that can be available to the cluster module, and its determination is completed within the DMS module by processing existing sensor inputs such as camera data monitoring eye gaze, head pose, blink rate, and inputs from steering wheel sensors or other driver-facing sensors. The DMS module may employ algorithms, including machine learning models, to interpret these sensor inputs and translate them into an attention score that at least in part determines the attention economy value.

Thus, the attention economy feature works with an DMS/OMS to provide an average or weighted average or moving average of a driver's attention over a period of time (e.g., over the current drive or trip, since the last reset of the values, for the past day/week/month, etc.). The attention economy may be displayed to the driver in a similar manner to fuel economy to allow the driver to continuously monitor attention (as opposed to a system that merely warns when attention has dropped below a threshold value). The attention economy may be based on image data captured by a camera disposed within the vehicle and/or based on other data, such as respiratory rates/variability, steering wheel hand sensors, driver-vehicle interaction patterns (e.g., frequency and type of control inputs), physiological data from wearable sensors integrated with the vehicle system, etc. The attention economy may provide context to vehicle accidents and for renting/borrowing vehicles, as people, for example, are more likely to trust attentive drivers over non-attentive drivers. Vehicle manufacturers, in some examples, may publish attention economy guidelines. For instance, a first variant of a vehicle might be more lenient in calculating the attention economy relative to a second variant of the vehicle because the first variant has certain other features (e.g., autonomous or semi-autonomous driving capabilities) that may compensate for the driver's lack of attention. For example, different attention zones viewed by the camera may be weighted differently (e.g., an attention zone that monitors the drivers hands on the wheel may be relaxed when semi-autonomous driving is enabled). Conversely, the second variant may lack these features and accordingly impose a stricter method of determining the attention economy (e.g., by adjusting threshold values for distraction or drowsiness indicators). The vehicle may include products/features that aid in increasing the attention economy of a driver. These features may capture attention, in-turn improving the attention economy. Such features may include interactive infotainment content designed to be less distracting, or adaptive interface elements that change based on the driver's assessed attention level to minimize cognitive load.

Modern vehicles are equipped with a wide array of technology and features and new features are continually added and may vary widely in availability and operation across different makes and models. It is important that the operator or driver of a vehicle understand how their vehicle operates and reacts to various situations and scenarios. While car dealerships may provide initial training to some consumers on their technology at vehicle pick-up or in the showroom, various scenarios, corner cases, and how the vehicle reacts may not or cannot be fully demonstrated or easily recalled by the driver later. At least some implementations herein include a driver trainer or a driver coach that advises drivers when there is feedback from a vehicle, explains why the feedback was received (as opposed to requiring the driver to search through a help menu or an owner's manual while driving or shortly thereafter). Frequently users are confused and sometimes distracted by why their vehicle has reacted in the way it has (e.g., an automated emergency braking (AEB) system, a lane keeping assist system (LKAS), a forward collision warning (FCW), an unexpected infotainment system behavior, etc.). The driver trainer aims to demystify these advanced features, thereby increasing driver confidence and appropriate reliance on such systems.

The driver trainer feature may help teach the driver why the vehicle reacted the way it did and act as a reminder or provide proactive coaching in situations that might match those of previous concern or that are known to be challenging for drivers. This helps the driver to understand new features in their vehicle so that the drivers do not just simply disable the features when they become frustrated or are not paying attention to how the system works and the vehicle feedback. The driver trainer is also able to provide new drivers or inexperienced drivers instruction or pointers as to how to improve their driving, such as advice on smooth acceleration and braking, maintaining appropriate following distances, proper lane discipline, effective use of mirrors, or anticipation of potential hazards based on sensor data. The system may identify a driver as new or inexperienced based on user profile selection, an initial period of driving behavior analysis, and/or based on a learner permit status.

The driver trainer explains to the driver why a warning signal was given (e.g., “Lane Keeping Assist activated because you drifted towards the lane marking without signaling”) and may monitor the driver's visual engagement (e.g., using the DMS/OMS camera to detect if the driver looks at the relevant display or acknowledges a prompt) to the feedback to see if they are attentive and/or understanding the feedback. The system may continue to provide the feedback or offer more detailed explanations when the event happens until the driver demonstrates understanding (e.g., by ceasing the behavior that triggered the warning or interacting with the HMI to confirm understanding) or is not sufficiently engaging with the content. When the driver is no longer engaging with the content despite repeated attempts by the system to convey information about a specific type of event, the system may determine that future interventions of that particular nature for that specific driver do not require visual feedback or explanation. Optionally, the system may default to a simpler audio cue or a brief textual notification or may suggest a dedicated learning module for that feature at the end of the trip.

The system may include a DMS/OMS camera system and allows for human-machine interface (HMI) interaction in visual, audible, and/or haptic feedback. When an event occurs, the system may display a message with a description explaining the event on the instrument cluster, center console display, or HUD. This would allow the driver to interact with the vehicle (e.g., via voice commands, touchscreen inputs, or steering wheel controls) and allow for additional explanation of why the vehicle reacted in this way and enable the driver to provide feedback to the vehicle about what action to take. For example, some interventions might be due to settings in various menus that users do not know about, and the system may explain the settings and offer a shortcut to adjust them (e.g., “AEB sensitivity is currently set to ‘High’. Would you like to adjust this setting?”). In another example, an intervention may include a particularly challenging scenario (e.g., an ADAS feature disengaging unexpectedly due to sensor limitations in adverse weather) in which a manufacturer of the vehicle may want detailed telemetry and/or contextual data captured to avoid other vehicles potentially having the same issue or to improve system robustness in future updates. The driver trainer may prompt the driver to confirm if they want to anonymously share data related to such an event.

The driver trainer system or feature may allow for drivers to provide anonymous feedback to manufacturers or other entities (e.g., via anonymous transactions of data as described in more detail below) when the system has reacted in a way that should be analyzed by engineering teams and not vehicle service teams. Issues with technology, particularly software-defined features or complex sensor interactions, are often reported to service centers which cannot always diagnose or repair such issues and the data is not readily available or in the correct format for the appropriate teams (e.g., engineering, design, and/or testing teams). This direct feedback loop may facilitate quicker identification of software errors, usability issues, or edge cases where system performance can be improved, leading to more rapid development cycles and over-the-air (OTA) updates if applicable. The system may categorize the feedback, for example, differentiating between perceived system errors, suggestions for improvement, or instances where the system performed correctly but its actions were unclear to the driver.

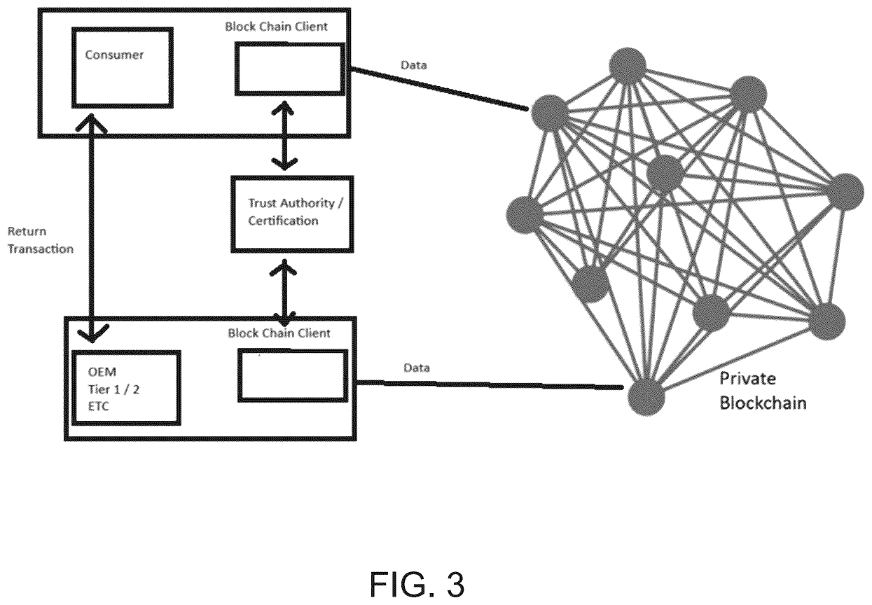

Referring now to FIG. 3, as more personal data (such as videos and images) captured or determined by vehicles is being stored and/or used by manufacturers, a vehicular communication system that enables end users to control their data and anonymity level allows for control and awareness with avoidance of doubt about whether a person has agreed to share their data. These implementations allow users of a vehicle to have an anonymous transaction of data with a manufacturer or other supplier of a vehicle and/or a third party (e.g., medical professionals, insurance providers offering usage-based incentives, or academic institutions for research purposes, etc.) by means of a block chain data transaction using a secure passkey, token, and/or code, which may be used, for example, to authorize access to their data segment on the blockchain, sign transactions, or decrypt their data for authorized parties. Utilizing cryptographic techniques such as pseudonymous identifiers on the blockchain, the system can ensure that data transactions do not directly reveal the user's real-world identity unless explicitly authorized. This is particularly important with potential implications that could be extracted by law enforcement (e.g., alcohol breath sensing, driving behavior patterns, or occupant status information). Users often want their data to be secure and to be aware of what their data might be used for, for example through a transparent interface detailing data requests and sharing agreements, optionally managed via smart contracts on the blockchain.

The data may be altered based on use case or user permissions. For example, the data may be full data with no visual adjustments, data with blurred key facial features, data with no visual images whatsoever, etc. Such alterations may be performed by on-board vehicle processing capabilities before data is committed to a transaction or by a trusted off-board service authorized through the blockchain protocol. Some manufacturers or other suppliers may consider rebates or offer payment for data and users should be able to see all the data being collected from their vehicle and allow opt in/opt out selections optionally with granular controls for different data types, recipient entities, and specific use-cases, with these preferences immutably recorded and enforced via the blockchain. Cost may depend on selections made by the user (e.g., opting in to share more comprehensive data may result in higher rebates or lower service fees, while opting for maximum privacy might involve a base service cost or limit access to certain data-dependent features).

The usage of blockchain control can extend not only to direct personal data, but product life cycle data in which a supplier may want to be protected from other manufacturers, suppliers, insurance, or extraction/interception by other non-approved parties. Examples of such product life cycle data include tracking component provenance, recording maintenance history, verifying software update authenticity and integrity, and managing recall information in a secure and auditable manner. The feature may be used in conjunction with cyber security methods. As shown in FIG. 3, the system may employ a private blockchain. The vehicle (or a user device in communication with the vehicle) may include a blockchain client that communicates with the private blockchain. A trust authority establishes trust between the user's blockchain client and the blockchain client of a manufacturer, supplier, or other entity attempting to access the data. The trust authority may be responsible for vetting participating entities, managing their identities or nodes on the private blockchain, and/or overseeing the governance protocols of the blockchain network. The blockchain infrastructure may enhance cybersecurity by, for example, providing a decentralized ledger for critical software updates thereby ensuring their authenticity and preventing unauthorized modifications, or by creating an immutable audit trail of data access and vehicle commands.

In some implementations, systems and methods herein include leveraging sensors of a vehicle to provide differential diagnosis or assessment of various health conditions for occupants of a vehicle. The system may generate a profile for each individual occupant of a vehicle over time (e.g., over multiple different drives) to establish a baseline for one or more health parameters. For example, the system gathers data on visual cues (e.g., skin tone, texture, eyes, body posture, body movements such as twitches or shakiness, pupil dilation, facial expressions indicative of pain or distress, involuntary eye movements, etc.), temperature, respiration rate, blood pressure, etc. over time to establish a baseline for the particular occupant. The system may update the profile of each occupant (based on identification of the occupant via, for example, facial recognition systems, user devices, user input, etc.) based on sensor data captured by various sensors (e.g., cameras, radar sensors, temperature sensors, heart rate sensors, microphones for detecting coughs or changes in speech patterns, cabin environment sensors monitoring air quality or CO2 levels, integrated sensors from wearable devices connected to the vehicle's network, etc.) during each drive. The baseline may be dynamically adjusted over longer periods to account for natural aging or slowly developing chronic conditions, distinct from acute changes that might trigger an alert.

The system may compare a current status of one or more health parameters of an occupant of the vehicle against that occupant's baseline. When the current status differs from the baseline by a threshold amount, the system may make a differential diagnosis or health status assessment highlighting potential anomalies and may alert the occupant, a medical professional, or any other appropriate entity of the change. The determination of this threshold amount may be personalized based on the occupant's known conditions, age, the sensitivity of the specific health parameter being monitored, and/or contextual factors such as current driving stress or environmental conditions. The system may periodically and privately provide information to other entities. For example, the system may provide data to a doctor for research or annual checkups.

The system may use a model (such as a machine learning model or neural network, for example, a convolutional neural network (CNN) for image analysis, a recurrent neural network (RNN) for analyzing time-series sensor data, a transformer-based model for complex pattern recognition in multimodal sensor inputs, etc.) to determine the current status of the health parameters. For example, the model may process image data captured by a camera to determine visual characteristics or cues of occupants of the vehicle and update the profiles of the occupants accordingly. These visual characteristics may include facial pallor, flushing, excessive sweating, fixed or dilated pupils, drooping eyelids, facial asymmetry, or changes in posture or gait when the occupant enters or exits the vehicle. The system may observe the occupants during specific scenarios that medical professionals cannot observe (e.g., high stress situations such as near-miss traffic incidents or sudden braking events, low cognitive load situations such as monotonous highway driving or during periods when the vehicle is parked and the occupant is resting). The model may be trained on diverse datasets encompassing various demographic groups and physiological responses to ensure robustness and fairness in its assessments. The system may employ techniques such as federated learning to train the model across multiple vehicles without directly sharing raw personal data in order to enhance privacy while improving model accuracy.

The system may allow for detection of sudden illnesses or rapid changes in status (e.g., fainting, symptoms indicative of a severe allergic reaction, or sudden onset of disorientation). The system may determine when a driver is no longer able to safely operate the vehicle and in response, slow the vehicle and/or move the vehicle off to the side of the road, activate hazard lights, and/or notify emergency services or a pre-designated contact. The system may provide haptic feedback (e.g., visual, audible, and/or haptic) when various changes are determined. The system may allow the user to provide feedback (e.g., the driver was having a particular emotional response that does not require medical care or to confirm/deny a potential health issue flagged by the system). This user feedback can be used by the system to refine its models and reduce false positives over time. The system may help diagnose or detect a number of health factors, such as heart attacks, strokes, insulin shock, seizures, and viral infections. For example, stroke detection may involve analyzing for sudden facial droop, arm weakness (e.g., by observing steering behavior or lack of movement), or speech difficulties (e.g., by processing voice commands or ambient conversation). Insulin shock may be indicated by erratic driving combined with pallor and sweating. Seizure detection may be triggered by observing convulsions or sudden unresponsiveness. Viral infection detection may be based on a combination of elevated temperature, coughing frequency, and changes in respiration patterns.

The system may monitor for particular facial expressions (e.g., looks of pain or discomfort, grimacing, wincing, or expressions of fear or anxiety) via processing of image data captured by a camera. The system may automatically provide baseline and current status information to emergency personnel or a hospital in the event of an accident or other serious event. The profile data may be encrypted for storage at the vehicle and/or prior to transmission. Optionally, severe medical emergencies may override one or more privacy or security options (e.g., encryption, approved medical service providers, etc.). For example, the system may be configured to only release medical information to a particular doctor associated with the user, but in a significant medical emergency (e.g., a loss of consciousness detected by the system, or following a severe collision detected by vehicle sensors), the system may allow the sharing of relevant portions of the medical information (such as allergies, pre-existing conditions from the health profile, and vital signs immediately preceding the event) to first responders or a nearby hospital to facilitate immediate and appropriate medical intervention. The system may use a color (e.g., RGB) camera to discern changes in color such as, for example, skin color changes of occupants. The system may integrate with one or more user devices, such as cell phones, smart watches, etc. For example, the system may receive additional data (e.g., heart rate data, blood oxygen saturation (SpO2) levels, electrocardiogram (ECG) data, glucose levels) from a smart watch worn by the user while driving. The system may utilize elements from the systems described in U.S. Publication Nos. US-2024-0112337 and/or US-2022-0363253, which are hereby incorporated herein by reference in their entireties.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in U.S. Pat. Nos. 10,099,614 and/or 10,071,687, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ultrasonic sensors or the like. The imaging sensor of the camera may capture image data for image processing and may comprise, for example, a two dimensional array of a plurality of photosensor elements arranged in at least 640 columns and 480 rows (at least a 640×480 imaging array, such as a megapixel imaging array or the like), with a lens focusing images onto the imaging array. The photosensor array may comprise a plurality of photosensor elements arranged in a photosensor array having rows and columns. The imaging array may comprise a CMOS imaging array having at least 300,000 photosensor elements or pixels, preferably at least 500,000 photosensor elements or pixels and more preferably at least one million photosensor elements or at least two million photosensor elements or pixels or at least three million photosensor elements or pixels or at least five million photosensor elements or pixels arranged in rows and columns. The imaging array may be sensitive to near-infrared light. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in U.S. Pat. Nos. 10,071,687; 9,900,490; 9,126,525 and/or 9,036,026, which are hereby incorporated herein by reference in their entireties.

The system may utilize sensors, such as radar sensors or imaging radar sensors or lidar sensors or the like, to detect presence of and/or range to objects and/or other vehicles and/or pedestrians. The sensing system may utilize aspects of the systems described in U.S. Pat. Nos. 10,866,306; 9,954,955; 9,869,762; 9,753,121; 9,689,967; 9,599,702; 9,575,160; 9,146,898; 9,036,026; 8,027,029; 8,013,780; 7,408,627; 7,405,812; 7,379,163; 7,379,100; 7,375,803; 7,352,454; 7,340,077; 7,321,111; 7,310,431; 7,283,213; 7,212,663; 7,203,356; 7,176,438; 7,157,685; 7,053,357; 6,919,549; 6,906,793; 6,876,775; 6,710,770; 6,690,354; 6,678,039; 6,674,895 and/or 6,587,186, and/or U.S. Publication Nos. US-2019-0339382; US-2018-0231635; US-2018-0045812; US-2018-0015875; US-2017-0356994; US-2017-0315231; US-2017-0276788; US-2017-0254873; US-2017-0222311 and/or US-2010-0245066, which are hereby incorporated herein by reference in their entireties.

The radar sensors of the sensing system each comprise a plurality of transmitters that transmit radio signals via a plurality of antennas, a plurality of receivers that receive radio signals via the plurality of antennas, with the received radio signals being transmitted radio signals that are reflected from an object present in the field of sensing of the respective radar sensor. The system includes an ECU or control that includes a data processor for processing sensor data captured by the radar sensors. The ECU or sensing system may be part of a driving assist system of the vehicle, with the driving assist system controlling at least one function or feature of the vehicle (such as to provide autonomous driving control of the vehicle) responsive to processing of the data captured by the radar sensors.

The radar sensor or sensors may be disposed at the vehicle so as to sense exterior of the vehicle. For example, the radar sensor may comprise a front sensing radar sensor mounted at a grille or front bumper of the vehicle, such as for use with an automatic emergency braking system of the vehicle, an adaptive cruise control system of the vehicle, a collision avoidance system of the vehicle, etc., or the radar sensor may be comprise a corner radar sensor disposed at a front corner or rear corner of the vehicle, such as for use with a surround vision system of the vehicle, or the radar sensor may comprise a blind spot monitoring radars disposed at a rear fender of the vehicle for monitoring sideward/rearward of the vehicle for a blind spot monitoring and alert system of the vehicle.

Optionally, the radar sensor or sensors may be disposed within the vehicle so as to sense interior of the vehicle, such as for use with a cabin monitoring system of the vehicle or a driver monitoring system of the vehicle or an occupant detection or monitoring system of the vehicle. The radar sensing system may comprise multiple input multiple output (MIMO) radar sensors having multiple transmitting antennas and multiple receiving antennas.

The system may utilize aspects of driver monitoring systems and/or head and face direction and position tracking systems and/or eye tracking systems and/or gesture recognition systems. Such head and face direction and/or position tracking systems and/or eye tracking systems and/or gesture recognition systems may utilize aspects of the systems described in U.S. Pat. Nos. 11,827,153; 11,780,372; 11,639,134; 11,582,425; 11,518,401; 10,958,830; 10,065,574; 10,017,114; 9,405,120 and/or 7,914,187, and/or U.S. Publication Nos. US-2024-0383406; US-2024-0190456; US-2024-0168355; US-2022-0377219; US-2022-0254132; US-2022-0242438; US-2021-0323473; US-2021-0291739; US-2020-0320320; US-2020-0202151; US-2020-0143560; US-2019-0210615; US-2018-0231976; US-2018-0222414; US-2017-0274906; US-2017-0217367; US-2016-0209647; US-2016-0137126; US-2015-0352953; US-2015-0296135; US-2015-0294169; US-2015-0232030; US-2015-0092042; US-2015-0022664; US-2015-0015710; US-2015-0009010 and/or US-2014-0336876, and/or U.S. patent application Ser. No. 18/864,663, filed Nov. 11, 2024 (Attorney Docket DON01 P4810), and/or U.S. provisional application Ser. No. 63/673,225, filed Jul. 19, 2024 (Attorney Docket DON01 P5202), and/or International PCT Application No. PCT/US25/27206, filed May 1, 2025 (Attorney Docket DON01 FP5372WO), which are all hereby incorporated herein by reference in their entireties.

Optionally, the driver monitoring system may be integrated with a camera monitoring system (CMS) of the vehicle. The integrated vehicle system incorporates multiple inputs, such as from the inward viewing or driver monitoring camera and from the forward-viewing camera, as well as from a rearward-viewing camera and sideward-viewing cameras of the CMS (e.g., a rearward-viewing camera disposed at the rear of the vehicle remote from the rear backup camera of the vehicle, and rearward-viewing cameras disposed at respective sides of the vehicle, such as at respective side-mounted exterior rearview mirror assemblies of the vehicle), to provide the driver with unique collision mitigation capabilities based on full vehicle environment and driver awareness state. The rearward viewing camera may comprise a rear backup camera of the vehicle or may comprise a centrally located higher mounted camera (such as at a center high-mounted stop lamp (CHMSL) of the vehicle), whereby the rearward viewing camera may view rearward and downward toward the ground at and rearward of the vehicle. The image processing and detections and determinations are performed locally within the interior rearview mirror assembly and/or the overhead console region, depending on available space and electrical connections for the particular vehicle application. The CMS cameras and system may utilize aspects of the systems described in U.S. Publication Nos. US-2021-0245662; US-2021-0162926; US-2021-0155167; US-2018-0134217 and/or US-2014-0285666, and/or International Publication No. WO 2022/150826, which are all hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A communication system, the communication system comprising:
a server operable to communicate with vehicles located remote from the server;
wherein the server is operable to receive an indication of an event that occurs remote from the server, the indication identifying a location associated with the event;
wherein the server, responsive to receiving the indication of the event, establishes a geofence that bounds the location associated with the event;
wherein the server transmits information pertaining to the established geofence to at least one of the group consisting of (i) a vehicle within the established geofence and (ii) a vehicle within a threshold distance of the established geofence; and
wherein, when a vehicle that received the transmitted information is within the established geofence, the server receives, from the respective vehicle within the established geofence, information derived from sensor data captured by at least one sensor of the vehicle within the established geofence.

2. The communication system of claim 1, wherein the event comprises an accident, and wherein the established geofence includes the accident.

3. The communication system of claim 1, wherein a size of the established geofence is dynamically determined based on at least one parameter selected from the group consisting of (i) a type of the event, (ii) a size of the event, (iii) a location of the event, (iv) current environmental conditions and (v) density of vehicular traffic.

4. The communication system of claim 1, wherein the received information comprises sensor data captured prior to the establishment of the geofence and stored in a memory buffer of the vehicle within the established geofence.

5. The communication system of claim 1, wherein the sensor data captured by the at least one sensor of the vehicle within the established geofence comprises at least one selected from the group consisting of (i) video streams, (ii) still images, (iii) radar detections, (iv) LIDAR point clouds, (v) audio recordings, (vi) vehicle telemetry data and (vii) environmental data.

6. The communication system of claim 1, wherein the received information comprises a status of at least one vehicle within the established geofence, and wherein the status comprises at least one selected from the group consisting of (i) type of the at least one vehicle, (ii) size of the at least one vehicle, (iii) position of the at least one vehicle, (iv) orientation of the at least one vehicle, (v) visible damage of the at least one vehicle, (vi) number of occupants in the at least one vehicle and (vii) status of vehicle systems of the at least one vehicle.

7. The communication system of claim 1, wherein the received information comprises a status of at least one person within the established geofence, and wherein the status comprises at least one selected from the group consisting of (i) position of the at least one person, (ii) movement of the at least one person, (iii) apparent injuries of the at least one person, (iv) indications of consciousness of the at least one person and (v) proximity to hazards of the at least one person.

8. The communication system of claim 1, wherein the server receives the indication of the event from at least one selected from the group consisting of (i) an in-vehicle automated emergency call system, (ii) a telematics service associated with a vehicle, (iii) a vehicle's integrated communication system and (iv) a smartphone application communicatively coupled to an emergency dispatch system.

9. The communication system of claim 1, wherein the server transmits information pertaining to the established geofence to (i) vehicles within the established geofence and (ii) vehicles within the threshold distance of the established geofence.

10. A vehicular sensing system, the vehicular sensing system comprising:
a camera disposed at a vehicle equipped with the vehicular sensing system and viewing exterior of the equipped vehicle;
wherein the camera is operable to capture image data;
wherein the camera comprises a CMOS imaging array, and wherein the CMOS imaging array comprises at least one million photosensors arranged in rows and columns;
an electronic control unit (ECU) comprising electronic circuitry and associated software;
wherein image data captured by the camera is transferred to the ECU;
wherein the electronic circuitry of the ECU comprises at least one image processor;
wherein the ECU is operable to process image data captured by the camera and transferred to the ECU;
wherein the vehicular sensing system is operable to determine that a current geographical location of the equipped vehicle is within an established geofence that bounds a location associated with an event; and
wherein the vehicular sensing system, responsive to determining that the current geographical location of the equipped vehicle is within the established geofence, transfers information derived from image data captured by the camera to a remote server associated with the established geofence.

11. The vehicular sensing system of claim 10, wherein the event comprises occurrence of an accident, and wherein the established geofence includes the accident.

12. The vehicular sensing system of claim 11, wherein emergency services establish the geofence at least in part responsive to occurrence of the accident.

13. The vehicular sensing system of claim 12, wherein the emergency services, based on information derived from the information transferred by the ECU, determine a scene within the established geofence.

14. The vehicular sensing system of claim 10, wherein the ECU determines that the current location of the equipped vehicle is within the established geofence based on determining that the equipped vehicle was involved in an accident.

15. The vehicular sensing system of claim 10, wherein the ECU determines that the current location of the equipped vehicle is within the established geofence based on a received wireless communication.

16. The vehicular sensing system of claim 10, wherein the established geofence is established by a remote service that is remote from the equipped vehicle at least in part responsive to occurrence of the event.

17. The vehicular sensing system of claim 10, wherein the information further comprises sensor data captured by at least one sensor.

18. The vehicular sensing system of claim 17, wherein the at least one sensor comprises a radar sensor.

19. The vehicular sensing system of claim 10 wherein the remote server receives information from a plurality of different vehicles within the established geofence.

20. A driver monitoring system, the driver monitoring system comprising:
a camera disposed at a vehicle equipped with the driver monitoring system and viewing interior of the equipped vehicle;
wherein the camera is operable to capture image data;
wherein the camera comprises a CMOS imaging array, and wherein the CMOS imaging array comprises at least one million photosensors arranged in rows and columns;
an electronic control unit (ECU) comprising electronic circuitry and associated software;
wherein image data captured by the camera is transferred to the ECU;
wherein the electronic circuitry of the ECU comprises at least one image processor;
wherein the ECU is operable to process image data captured by the camera and transferred to the ECU;
wherein the driver monitoring system, via processing at the ECU of image data captured by the camera, determines a current attentiveness of the driver of the vehicle;
wherein the driver monitoring system, responsive to determining the current attentiveness of the driver over a period of time while the driver is driving the vehicle, determines an attention economy of the driver, and wherein the attention economy defines an attentiveness of the driver over the period of time; and
wherein the driver monitoring system displays the attention economy on a display disposed within the equipped vehicle and viewable by the driver of the vehicle.

21. The driver monitoring system of claim 20, wherein the driver monitoring system determines a plurality of attention zones within view of the camera, and wherein the current attentiveness of the driver is based on each of the plurality of attention zones, and wherein the current attentiveness of the driver is based on an average of each of the plurality of attention zones, and wherein each zone of the plurality of attention zones is weighted.

22. The driver monitoring system of claim 21, wherein the weights of each zone of the plurality of attention zones is based on other advanced driving assistance systems available to the driver of the equipped vehicle.

23. The driver monitoring system of claim 21, wherein the weights of each zone of the plurality of attention zones is based on a current driving scenario.

24. The driver monitoring system of claim 20, wherein the driver monitoring system, responsive to receiving a warning signal generated by the equipped vehicle, displays an explanation of an associated warning indicator to the driver of the vehicle, and wherein the driver monitoring system, responsive to processing of image data captured by the camera, determines a response of the driver of the vehicle to the displayed explanation, and wherein the driver monitoring system, responsive to receiving a second warning signal generated by the equipped vehicle, displays a second explanation of an associated second warning indicator to the driver of the vehicle when the response of the driver to the explanation fails to satisfy a threshold, and wherein the driver monitoring system does not display the second explanation of the second warning signal to the driver of the vehicle when the response of the driver to the explanation satisfies the threshold.
